(19) United States
(12) Patent Application Publication
(10) Pub. No.: US 2016/0007560 A1
(43) Pub. Date: Jan. 14, 2016

(54) Animal waste pad system

(71) Applicant: Jang Roofener, Oakley, CA (US)

(72) Inventor: Jang Roofener, Oakley, CA (US)

(21) Appl. No.: 14/120,922

(22) Filed: Jul. 11, 2014

(51) Int. Cl. A01K 1/01

(52) U.S. Cl. CPC A01K 1/0117; A01K 1/0135

(57) ABSTRACT

An animal waste pad system with a housing where on one side is a roll of sheet material capable of supporting animal waste and on the other side contains a sheet end pulling assembly and a sheet folding assembly. A flat sheet supporting member is located between the two. A motion sensor is positioned to sense the presence of an animal standing on the flat sheet supporting member. A microprocessor controls the sheet end pulling assembly and the sheet folding assembly so that when the animal leaves the sheet material the sheet pulling and folding assemblies pull the sheet into the housing storage area until a person cuts off the used sheet and disposes of it.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pet waste disposal systems and more specifically to animal waste pad system.

Pet animals such as dogs and cats often are forced to live indoors for extended periods of time. These pets need a way to relieve themselves of urine or feces in a way that is contained and easily disposed of by the pet's owner. Many cat owners use litter boxes where an absorbent material is placed in the box and the cat owner periodically scoops out pet waste from the box and disposes of it in a standard way. Dog owners usually walk their dogs outside a few times a day and carry bags to pick up feces and dispose of it in a trash can. Some dog owners put down a sheet of absorbent material in a room of their homes or apartments. The sheet has a water resistant base layer so that if the dog urinates or poops on the sheet, it will not seep onto the floor. When the pet owner returns home, he or she can then pick up the soiled sheet and dispose of it in the trash.

Some inventors have proposed ways of improving the sheet system. For example Barry Askenasi in his patent application 2010/0175626 discloses a housing that stores a roll of sheet material in a housing which can be pulled out and placed on a flat plate. After the sheet is used, the dog owner can tear off the soiled sheet and pull out a new one. U.S. Pat. No. 8,316,801 by John Nottingham et al discloses a waste disposal system that includes a pair of central rollers that roll left and right waste sheets into a collection box under the waste collecting platform.

However there are deficiencies in the prior technology. The Askinasi design requires that the pet owner pull out and tear off the soiled sheet after each use. If the sheet is used while the pet owner is away, and the pet has to go again, there is a good chance that the pet will find another spot to relieve himself other than the area that contains the already soiled sheet. The Nottingham patent attempts to solve this problem by employing a mechanism that draws the waste sheet or pad into a box below the sheet supporting surface. However, this design requires that the excrement on the sheet be squeezed between two sheets before being stored in the box below. The real life success of this process is questionable in that it is difficult to predict the amount or consistency of the excrement which would make it difficult to cleanly dispose of the waste. Additionally, since the storage box is located below the pad supporting surface, the pet is required to hop up on the surface, which my be an impediment to a pet actually using the device, since dogs normally defecate or urinate on a surface that is on the ground or in very close proximity to the ground.

### BRIEF SUMMARY OF THE INVENTION

The primary object of the invention is to provide an animal waste pad system that stores a roll of sheet material and automatically dispenses waste sheets onto a flat surface as needed by the animal.

Another object of the invention is to provide an animal waste pad system that automatically folds and stores used waste sheets until disposed of by the user.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an animal waste pad system comprising: a housing, a roll of sheet material capable of supporting animal waste, a sheet roll retaining member, a sheet end pulling assembly, a sheet folding assembly, a flat sheet supporting member, a motion sensor, a microprocessor circuit and a power supply; said housing enclosing said sheet roll retaining member on one side and said sheet pulling and folding assembly on the opposite side, and said flat sheet supporting member attached on one side to said sheet roll retaining member and on the opposite side to said sheet pulling and sheet folding assembly, said motion sensor positioned to sense the presence of an animal standing on said flat sheet supporting member, said microprocessor assembly controlling said sheet end pulling assembly and said sheet folding assembly, said power supply providing electrical energy to said sheet folding and pulling assemblies and said microprocessor circuit.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with the housing covers in the open position.

FIG. 3 is a partial side section view of the sheet pulling assembly with the pinch finger in the use position.

FIG. 4 is a partial side section view of the sheet pulling assembly with the pinch finger in the non-use position.

FIG. 5 is a top view of the invention in the ready to use position.

FIG. 6 is a top view of the invention with the housing top removed.

FIG. 7 is a top view of the invention with the sheet pulled to the farthest position.

FIG. 8 is a top view showing the folding flaps folding over the pulled sheet.

FIG. 9 is a top view showing the pinch finger ready to pull the folded sheet into the housing.

FIG. 10 is a top view showing the folded sheet completely pulled into the housing.

FIG. 11 is a side view of the sheet after it has been folded several times.

FIG. 12 is a block diagram of the pulling and folding system of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

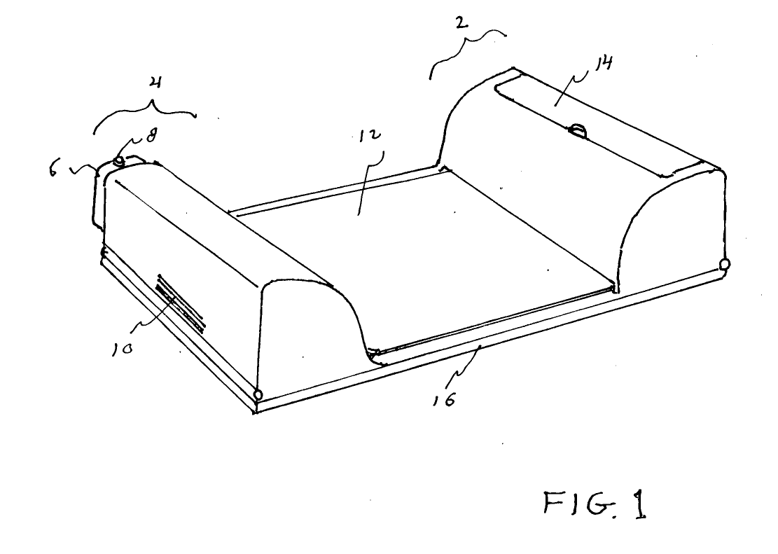

Referring now to FIG. 1 we see a perspective view of the invention 100. A housing is comprised of a sheet roll retaining portion 2 a flat sheet supporting plate 36 that supports waste receiving pad or sheet 6 and a sheet pulling and folding housing portion 4. A pet, such as a dog can be trained to urinate or defecate on the pad portion 6 of sheet roll 10 because the sheet contains attractants that are desirable to a dog. It should be noted that the present invention 100 can also be used for cats and other types of pet animals that live indoors. Motion sensing members 46, 48 sense when an animal enters the waste receiving area and when the animal leaves the area.

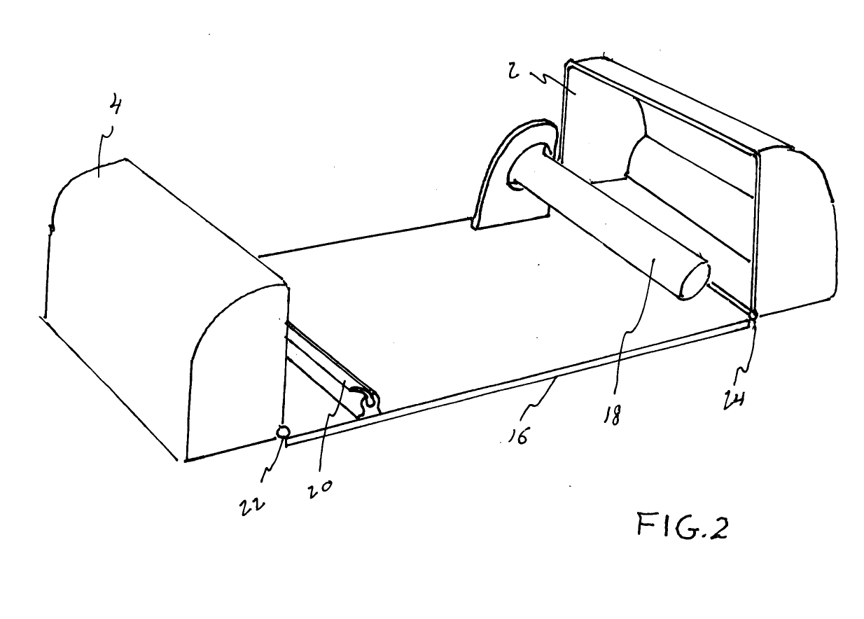

FIG. 2 is a perspective view of the invention with the housing lids 8, 12 lifted to reveal sheet roll 10 on the roll retaining side 2 and the sheet pulling assembly 18 and folding flaps 14 on the opposite side 4.

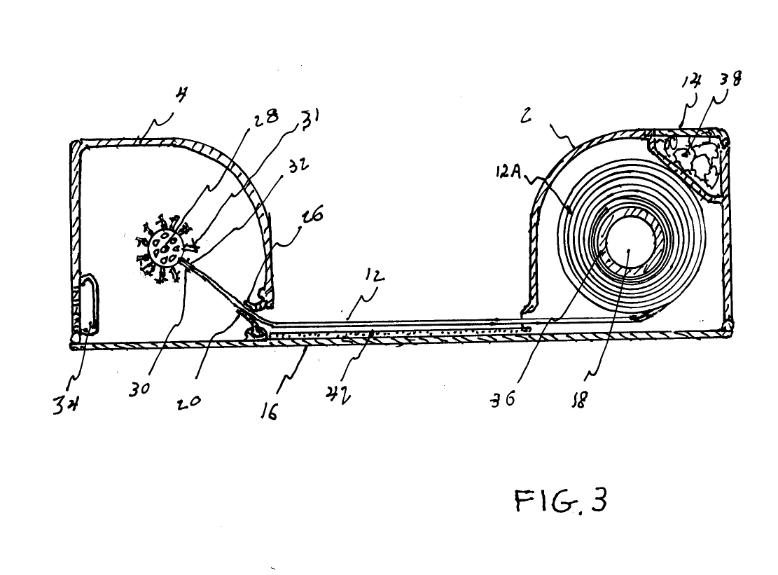

FIG. 3 is a partial side section view of the sheet pulling and folding side of the invention. Housing cover 12 is attached to the base portion 52 via hinge member 50. Gear motor 30 turns threaded shaft 16. As shaft 16 turns it causes nut 54 and attached sheet pulling assembly 18 to advance or retract as necessary. In the present view the sheet 6 has been pulled to the extreme left side by pulling assembly 18. The pulling assembly 18 is comprised of a pinch finger 22 which can rotate about gear shaft 28. Gear shaft 28 is turned by drive gear 26 powered by gear motor 27. The rotating pinch finger presses against stationary pinch finger 23 which traps the end of the sheet 6 so that it can be pulled. When activated, the pinch finger can go from the pinch position 22 to the release position as shown by dotted line 24. Folding paddle 14 can be seen under sheet 8. the folding paddle can rotate about shaft 38.

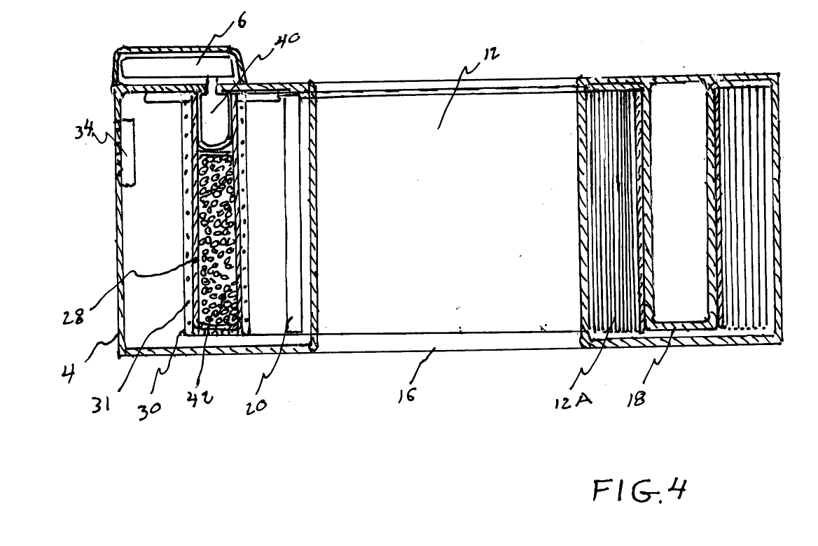

FIG. 4 is a partial side view showing the folding paddle 14 after it has folded sheet 6. The folded portion is shown as 6A. The pinch finger 22 is in the lifted position which allowed the sheet portion 6A to be freely folded. The arc of the folding paddle 14 can be seen in dotted line 32. Support plate 36 can be seen supporting sheet material 6. The sheet pulling motor 30 is located just under support panel 36. Support ribs 37 are the same height as the diameter of the pull motor 30 which is approximately three quarters of an inch.

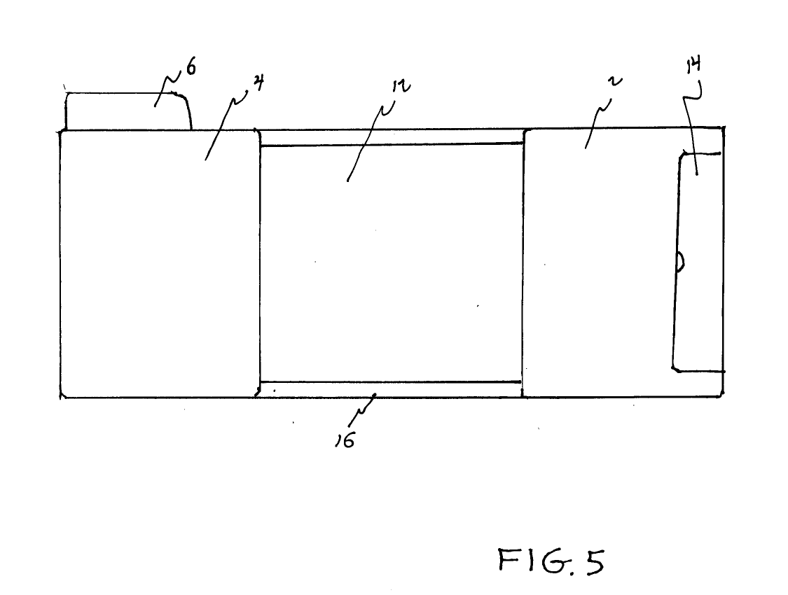

FIG. 5 is a top view of the invention 100. Pinch finger 22 is in the position that is ready to pull the sheet 6 into the sheet pulling and folding housing 4.

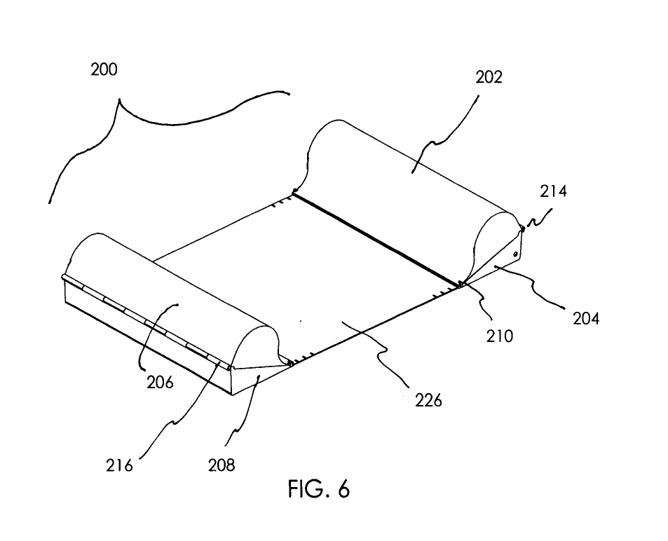

FIG. 6 is a top view of the invention with the housing covers 8, 12 removed and roll 10 and sheet 6 removed. Roll retaining member 34 holds the center of roll 10. Support plate 36 is clearly seen and is held up by support ribs 37 located under the plate 36. Pull motor 30 is centrally placed in the space where support ribs 37 are not found. Folding shaft 38 and folding paddles 14 are also clearly seen. The shaft of folding motor 40 is connected to folding shaft 38. Battery power supply 42 supplies electricity to all motors and a microprocessor circuit 44.

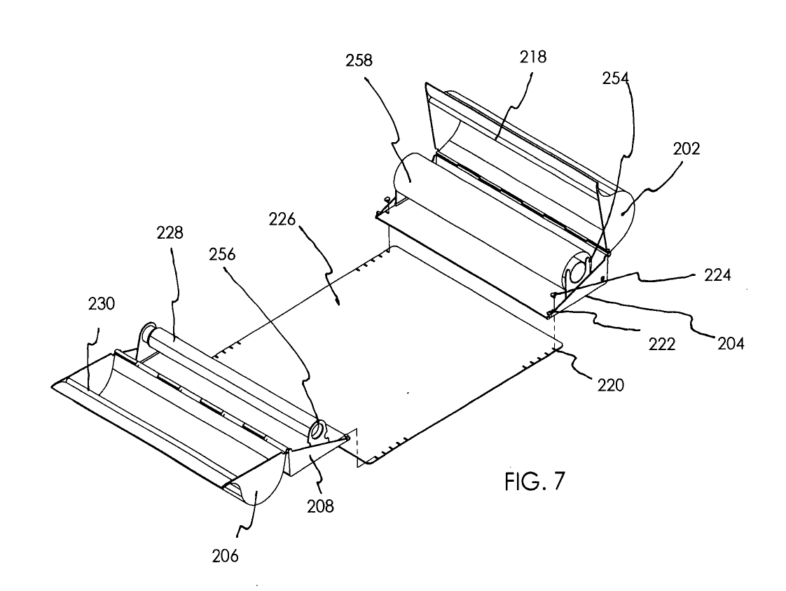

FIG. 7 is a top view showing the pinch finger pulling the sheet 6 to the far position.

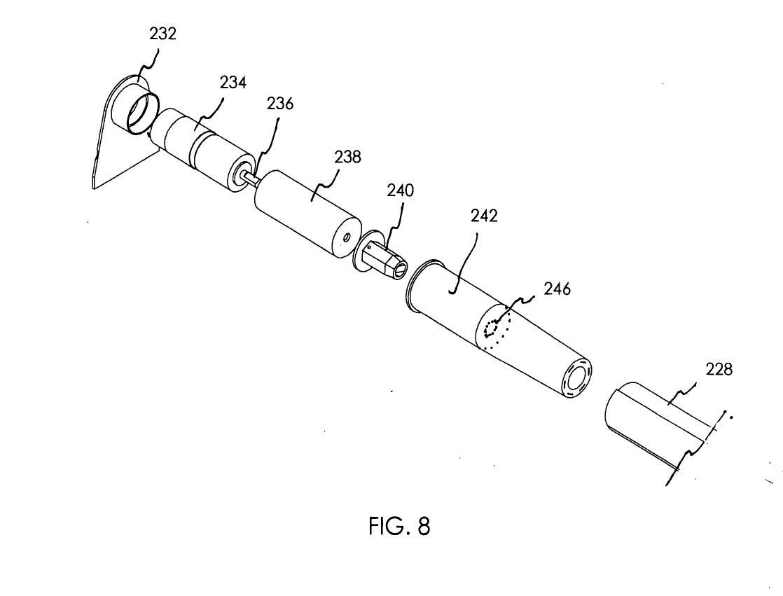

FIG. 8 shows the folding paddles 14 after they have folded sheet 6 creating folded sheet portion 6A. Pinch finger 22 is in the raised position allowing the folded sheet 6A unimpeded freedom to fold.

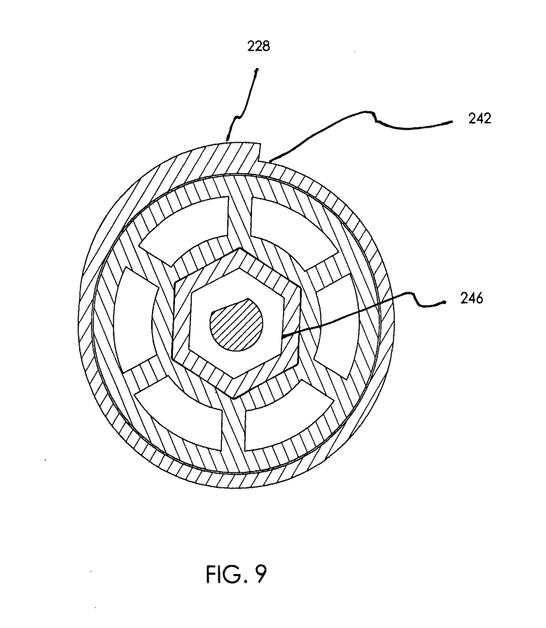

FIG. 9 shows the pinch finger 22 advanced to the fold and pinching the folded sheet 6A so that it can be pulled back into the housing 4.

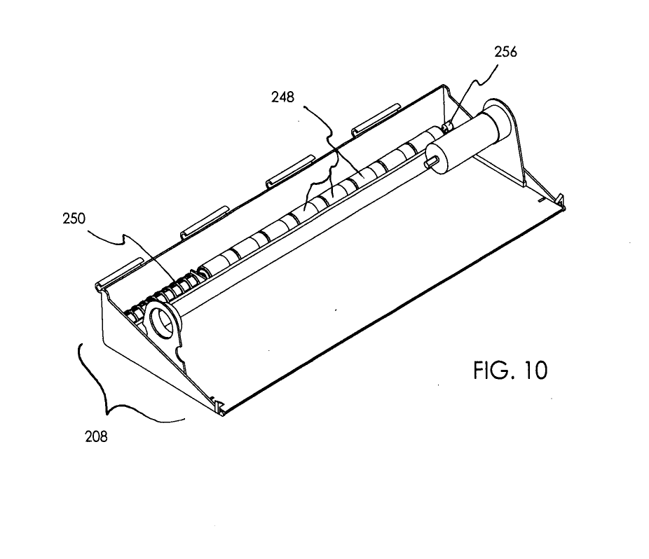

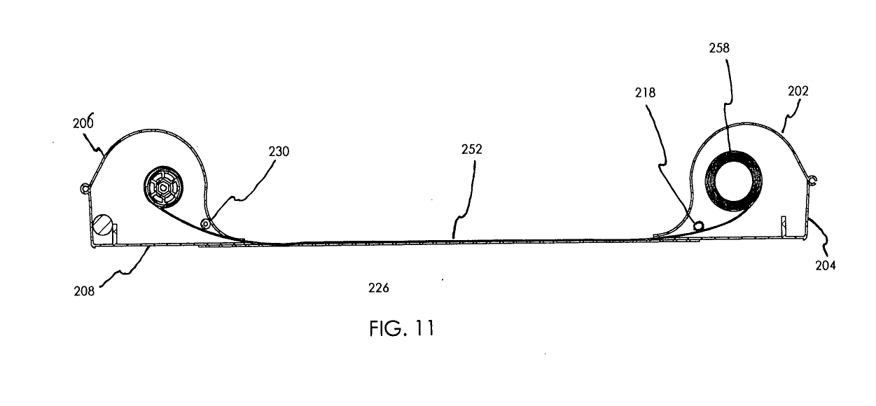

FIG. 10 shows the folded portion 6A fully drawn into the housing portion 4. The pulling and folding process can now repeat several times to draw the entire contents of sheet 6 into the housing 4 as shown in the side view of sheet 6 in FIG. 11. The folding portions can retain the used sheet 6 that contain urine and excrement. There is enough room in housing area 4 so that a dog or other pet can use the device 100 multiple times during a day or over several days before the owner of the pet needs to remove the folded sheet. For removal, the owner cuts the sheet using standard means such as a scissors, paper cutter or electric scissors and readies the invention for a the next use.

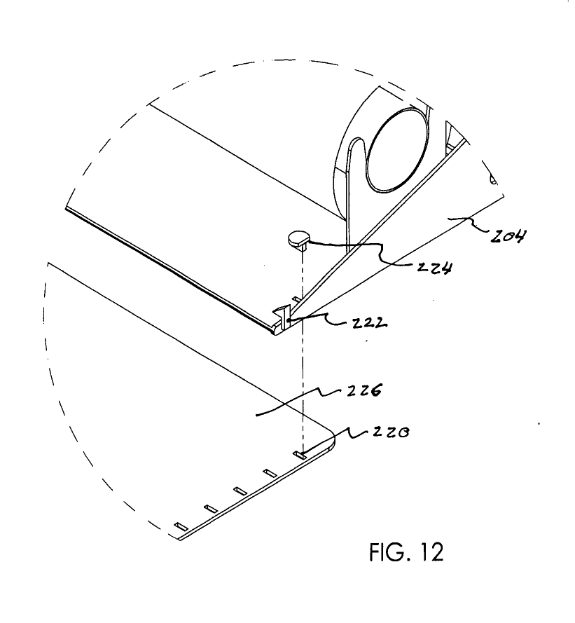

FIG. 12 is a block diagram showing the sequence of events as directed by microprocessor circuit 44 in the pulling and folding process of the present system of the invention 100. Block 60 indicates that Sensors see the animal leave the pad. Block 62 indicates the sheet pulling assembly is pulling the sheet into the housing. Block 64 indicates the pinch finger raising. Block 66 indicates the folding paddles rotating and folding the sheet. Block 68 indicates the sheet pulling assembly advancing to the edge of the folding sheet. Block 70 indicates the pinch finger lowering to the folded sheet edge. Block 72 indicates the sheet pull assembly retracting and drawing in the folded sheet into the housing. Block 74 indicates the return to block 54 to repeat the folding process as needed.

It should be noted that a special sheet having a layer of fine gravel adhered to the absorbent sheet 6 can be used for cats, which like to scratch on gravel-like material after relieving themselves. In this way, the present invention 100 can replace the traditional kitty litter boxes found in millions of homes.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. animal waste pad system comprising:
a housing;
a roll of sheet material capable of supporting animal waste;
a sheet roll retaining member;
a sheet end pulling assembly;
a sheet folding assembly;
a flat sheet supporting member;
a motion sensor
a microprocessor circuit
a power supply
said housing enclosing said sheet roll retaining member on one side and said sheet pulling and folding assembly on the opposite side; and
said flat sheet supporting member attached on one side to said sheet roll retaining member and on the opposite side to said sheet pulling and sheet folding assembly;
said motion sensor positioned to sense the presence of an animal standing on said flat sheet supporting member;
said microprocessor assembly controlling said sheet end pulling assembly and said sheet folding assembly;
said power supply providing electrical energy to said sheet folding and pulling assemblies and said microprocessor circuit.

2. animal waste pad system as claimed in claim 1 wherein said sheet pulling assembly includes a motorized lead screw and nut;
said nut attached to a slidable housing that encloses a gear motor that activates an external rotatable pinch finger which can press against a lower stationary pinch finger.

3. animal waste pad system as claimed in claim 1 wherein said sheet folding assembly includes a pair of folding paddles attached on one edge to a shaft;
said shaft attached on one side to the inside wall of said housing and on the opposite side to a gear motor shaft.

4. animal waste pad system as claimed in claim 1 wherein said flat sheet supporting member is rigid and includes structural ribs that have a height that matches the height of said sheet pulling motor.

5. animal waste pad system as claimed in claim 1 wherein said motion sensor senses when an animal has left the flat sheet supporting member causing said microprocessor to instruct the pinch finger of said sheet pulling assembly to pull the end of said sheet material toward the inside wall of the said sheet folding portion of said housing and then said microprocessor instructs said pinch finger to release said sheet material and cause said folding assembly to fold said sheet over on itself and then for said pinch finger to rotate and grab the edge of said folded sheet and then for said sheet pulling assembly to pull said folded sheet towards the inside wall of said housing and to repeat said sequence as needed to fold and store used waste sheet until a person cuts off the used portion of said sheet material and disposes it.
